(19) United States
(12) Patent Application Publication
(10) Pub. No.: US 2005/0108011 A1
(43) Pub. Date: May 19, 2005

(54) System and method of templating specific human voices

(76) Inventors: Steven J. Keough, St. Paul, MN (US); Katherine Axia Keough, St. Paul, MN (US)

Correspondence Address: STEVEN J. KEOUGH, 1912 SUMMIT AVE, ST PAUL, MN, 55105, US

(21) Appl. No.: 11/012,792

(22) Filed: Dec. 14, 2004

Related U.S. Application Data
(63) Continuation of application No. 09/972,730, filed on Oct. 4, 2001.

(51) Int. Cl. G10L 15/00

(52) U.S. Cl. 704/243

(57) ABSTRACT

Systems and methods are disclosed to capture an enabling portion of a voice and then to create a voice template or profile signal which may be combined at a later time with noise of another origin to reconstitute the original voice. Such reconstituted voice may then be used to speak any form or content provided via digital input thereto, and to say content which was not spoken in an original form by the original voice. Products and processes for online use are disclosed, as are certain business methods and industry applications.

### FIELD OF THE INVENTION

Systems, methods, and products for preserving and adapting sound, and more specifically human voices.

### BACKGROUND OF THE INVENTION

Since the beginning of time mammals and other creatures have communicated in some form by voice or similar noises. Indeed, such noises are normally quite distinct in view of the differences in morphology of creatures—even within species. The distinctiveness of creatures includes the very distinct elements of speech patterns and tones. Unfortunately, the joy of listening to the speech of others with a voice of particular interest is lost when that person dies or ceases contact with the listener.

Only the very basic forms of media capture exist today by which voices may be preserved. For example, a tape or digital recording device is used to record someone's voice and thereby retain it for future listening and replay as it was recorded originally, or portions of the original recording may be played as desired. These devices and methods of voice recording also include a range of artificial voices, created by computers, which may be used for many different functions, including for example telephone automatic assistance and verification, very basic speech between toys or equipment and users, synthesized voices for the film and entertainment industry, and the like. In some applications, these artificial voices are preprogrammed to a narrow set of responses according to a specific input. Although more responsive, in some instances, than a mere recording of an actual voice, these artificial voice sounds are nevertheless simple compared to the robust voice capabilities of the present invention. Indeed, in certain embodiments of the invention there are elements that are either quite different from such systems or which take the previous technology far beyond that ever contemplated or even suggested by such prior discoveries or innovations.

Many publications worldwide disclose aspects of artificial vocalization. In similar fashion, some references disclose systems and techniques of using and creating artificial voice sounds. However, none of these references disclose the concepts of the present invention.

### BRIEF DESCRIPTION OF THE DRAWINGS

FIG. 1 is a flow diagram of one embodiment of the system operation of the invention.

FIG. 2 is a schematic diagram of one embodiment of a voice capture subsystem.

FIG. 3 is a schematic diagram of one embodiment of a voice analysis subsystem.

FIG. 4 is a schematic diagram of one embodiment of a voice characterization subsystem.

FIG. 5 is a schematic diagram of one embodiment of a voice template subsystem.

FIG. 6 is a schematic diagram of one embodiment of a voice template signal bundler subsystem.

FIG. 7 is one embodiment of a schematic diagram of the system of the invention used with remote information download and upload options.

FIG. 8 is one embodiment of an exemplary plan view of an embodiment of the invention embodied in a mobile, compact component.

FIG. 9 is an exemplary plan view of an embodiment of the invention used with a visual media source.

### SUMMARY OF THE INVENTION

Systems and methods are provided for recording or otherwise capturing an enabling amount of a specific person's voice to form a voice pattern template. That template is then useful as a tool for building new speech sounding like that precise voice, using the template, with the new speech probably never having been actually said or never having been said in the precise context or sentences by the specific human but actually sounding identical in all aspects to that specific human's actual speech. The enabling portion is designed to capture the elements of the actual voice necessary to re-construct the actual voice, however a confidence rating is available to predict the limits of the re-constructed or re-created speech in the event there is not enough enabling speech to start with. A new voice or voices may be used with a database of subject matter, historical data, and adaptive or artificial intelligence modules to enable new discussions with the user just as if the templated voice's originator were present. This system and method may be combined with other media, such as a software file, a chip embedded tool, or other forms. Interactive use of this system and method may occur in various manners. A unit module itself may comprise the entirety of an embodiment this invention, e.g. a chip or electronic board which is configured to capture and enable use of a voice in the manner disclosed herein.

The template is useful, for example, as a tool for capturing and creating new dialogs with people whom are no longer immediately available, who may be deceased, or even those who consent to having the voices templated and used in this manner. Another example is the application to media, such as film or photos or other depictions of the actual voice(s) originator to create on-demand viral dialog with the originator. Various other uses and applications are contemplated within the scope of the invention.

### DETAILED DESCRIPTION OF THE INVENTION

Voice is a sound of extraordinary power among mammals. The sound of a mother's voice is recognized by and soothes a child even before birth, and the sound of a grandfather's voice calms the fears of even a grown person. Other voices may inspire complete strangers or may elicit memories from loved ones of long past events and moments. These are but a few examples of the great gift of distinctiveness that the human and other species have; and their ability to influence others (and themselves) by the very unique sound of each creatures' voice. In humans, for example, this particularity of one's voice derives from the genetic contribution of the parents resulting in the shape, size, position and development of the various human body components that influence the way one sounds when speaking or otherwise communicating with voice or through the mouth and nasal passages. Other influences exist as well. It is understandable therefor that there is a range of differences among people, often even within the same family. Indeed, even the same person may sound slightly different according to temporal influences such as the health, stress level, emotional state, fatigue, the ambient temperature around the person, or other factors.

There is general agreement worldwide, however, that a person's voice qualities present a very unique combination, that is discernible to those who have heard the voice before. The ability of humans to associate through their senses is remarkable, particularly as such sensing relates to identification and association with the human voice. Life's grand and small events are often recalled many years or decades later by the nature of comments made or tones remembered. Thus is the enduring strength and emotive power of voice.

It is of course well known to capture and play back human voice on various media and machines. Basic manipulation of recorded human voice has been done for many decades, both intentionally and unintentionally, in tape and digital media. However, this manipulation has been generally limited by the bounds of what has actually been stated by the human rather than what could be stated by that human. For example, segments of actual statements by the human have been played, edited, mixed and re-played, sometimes even at different speeds. Other examples of human voice use include playback of intentionally distorted voice segments, such as may be used in cartoons or other audio related to animation or certain music. Of course, the animation medium also has used artificial voice not necessarily created using actual voice. One example of this is a computer generated “voice” operator used by some telephone and communication systems. One method of synthesizing voices and sounds is referred to as concatenative, and refers to the recordings of wave form data samples or real human speech. The method then breaks down the pre-recorded original human speech into segments and generates speech utterances by linking these human speech segments to build syllables, words, or phrases. The size of these segments varies. Another method of human speech synthesis is known as parametric. In this method, mathematical models are used to recreate a desired speech sound. For each desired sound, a mathematical model or function is used to generate that sound. As such, the parametric method is generally without human sound as an element. Finally, there are generally a few well-known types of parametric speech synthesizers. One is known as an articulatory synthesizer, which mathemetically models the physical aspects of the human lungs, larynx, and vocal and nasal tracts. The other type of parametric speech synthesizer is known as a formant synthesizer, which mathematically models the acoustic aspects of the human vocal tract.

Other systems include means for recognizing a specific voice, once the using system has been trained in that voice. Examples of this include the various speech recognition systems useful in the field of capturing spoken language and then translating those sounds into text, such as with systems for dictation and the like. Other speech related systems concern the field of biometrics, and use of certain spoken words as security codes or ciphers. None of these systems, methods, means or other forms of disclosure recognize the various inventions disclosed herein, nor do any such disclosures even recognize a need for such technical innovations. What has long been needed is a system and method for preserving the voices of other beings in a dynamic and adaptive manner for future use and benefit by the originator or by others. What has been further needed are systems and methods for accomplishing and utilizing such voice capture or profiling in manners which present a seamless, articulate, or otherwise genuine vocalization or voice in the voice of the original person in ways possibly never contemplated by that person. Certain additional advantages accrue to systems and methods for accomplishing this which are easily used by all people of virtually any skill, culture or language. What has been further needed is a new business method, technique and model, along with implementing apparatus and other means, to create and to facilitate access to specific voice templates and then facilitate use of those voice templates for personal needs or desires, whether related to business or pleasure. Once again, although much has been accomplished in the field of voice technology, none of these past efforts contemplate the instant inventions and merely highlight the novel and heretofore unrecognized need for these inventions.

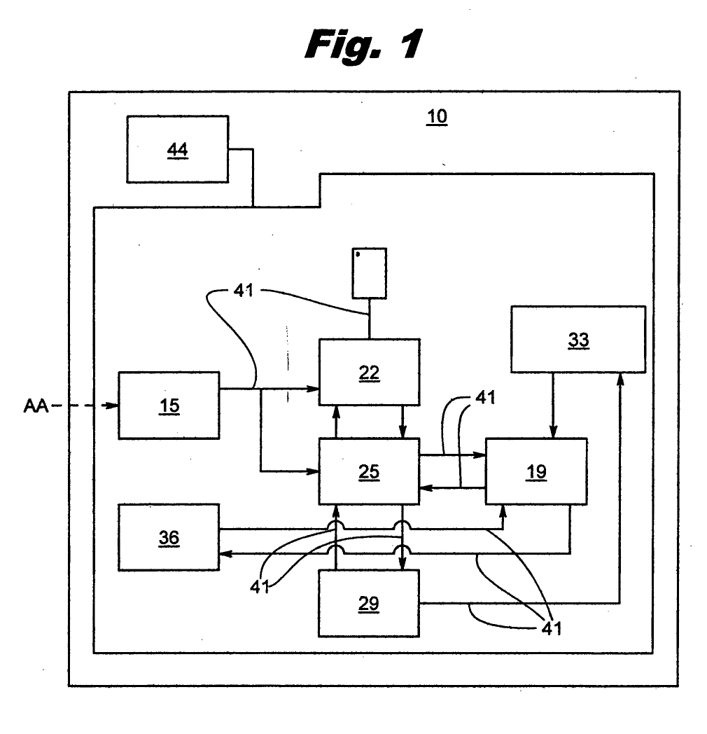

FIG. 1 is a schematic diagram of one embodiment of a system 10 for capturing an enabling portion of a specific voice sufficient for using that portion as a template in further use of the voice characteristics. System 10 may be part of a handheld device, such as an electronic handheld device, or it may be part of a computing device of the size of a laptop, a notebook, or a desktop, or system 10 may be part of merely a circuit board within another device, or an electronics component or element designed for temporary or permanent placement in or use with another electronic element, circuit, or system, or system 10 may, in whole or in part, comprise computer readable code or merely a logic or functional circuit in a neural system, or system 10 may be formed as some other device or product such as a distributed network-style system. In one embodiment, system 10 comprises input or capture means 15 for capturing or receiving a portion of a voice for processing and construction of a voice algorithm or template means 19, which may be formed as a stream of data, a data package, a telecommunications signal, software code means for defining and re-generating a specific voice, or a plurality of voice characteristics organized for application to or template on another organization of sound or noise suitable to arrange the sound or noise as an apparent voice of an originator's voice. Other means of formatting computer readable program code means, or other means, for causing use of certain identified voice characteristics data to artificially generate a voice is also contemplated within this invention. The logic or rules of the algorithm or template means 19 are preferably formed with a minimum of voice input, however various amounts of voice and other data may be desired to form an acceptable data set for a particular voice.

In one embodiment of the invention, it is desired to capture an enabling portion of a human voice, for example, with a small amount of analog or digital recording, or real-time live input, of the person's voice that is to be templated. Indeed, a prescribed grouping of words may be formed to optimize data capture of the most relevant voice characteristics of the person to enable accurate replication of the voice. Analysis means are contemplated for most efficiently determining what form of enabling portion is best for a particular person. Whether by a single data input or a series of inputs, the voice data is captured and stored in at least one portion of storage means 22.

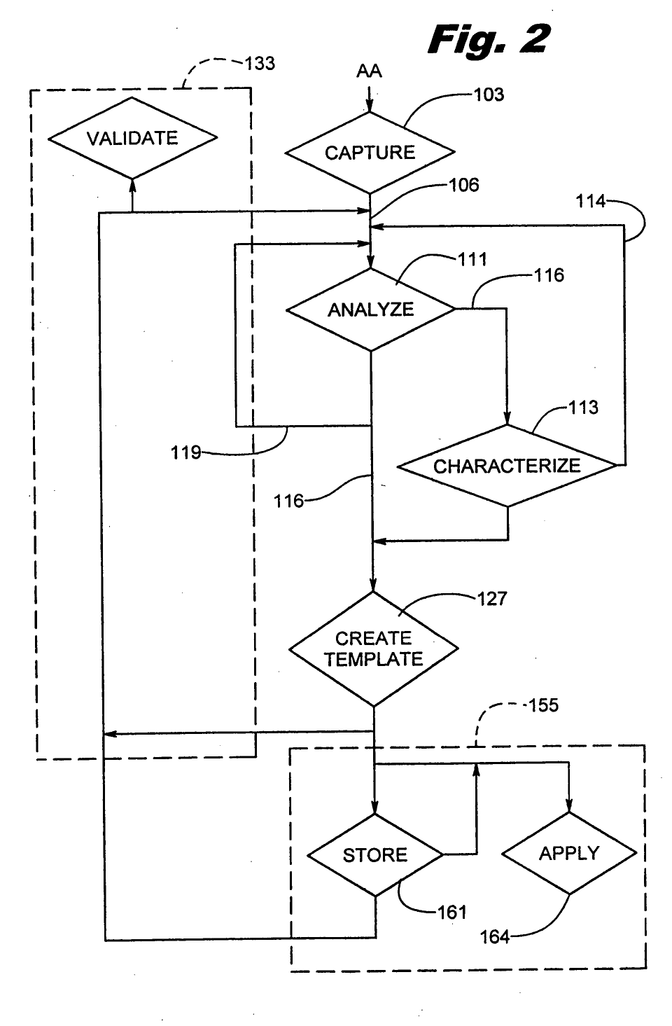

Analysis of the voice data is performed at processor means 25, to identify characteristics useful in creating a template of that specific user's voice. It is recognized that the voice data may be routed directly to the processor means and need not necessarily go initially to the storage means 22. Further exemplary discussion of the interaction among the processor means, storage means, and the template means is found below, and in relation to FIGS. 2-8. After adequate voice data has been analyzed, then a template of the voice is, in one embodiment, stored until called for by the processor means 25. For example, after voice AA has had an enabling portion captured, analyzed and templated (now referred to as AAₜ) it is stored in a storage means 22 (which may be either resident near the other components or located in a remote or distributed mode at one or more locations) until a demand request occurs. One example of a demand request is a user of system 10 submitting a request via representative input means 29 to utilize the voice AA template AAₜ in a newly created conversation with voice AA participating as a generated voice rather than an actual, live use of voice AA. This may occur in conjunction with or utilization of one or more various databases, a few of which are represented by situational database 33 or personal database 36. In turn, then voice AA template AAₜ is called and provided as a forming mechanism with certain other noise to create a new conversational voice AA¹ that sounds precisely like the original voice AA of the originally inputted data, once formed. Although the new voice AA¹ sounds like original voice AA in all respects, it is actually an artificially created voice with the template AAₜ providing the matching key, such as a genetic code, to voice AA. In this way an enabling portion of an actual voice may encode the system 10 using a template to allow regeneration and unlimited utilization of the captured voice in virtually any way desired by the user. This is not simply a synthesis of prior utterances of bits of voice AA which are electronically fused together, by either concatenation or formant techniques, but rather an entirely new voice that is designed, manufactured and assembled or constructed using the voice data characteristics of voice AA (i.e., the voice template or profile), and possibly other characteristics relevant to the originator of voice AA, e.g. genetic code, tissue DNA applicable to a specific voice, or other physiologic precursor.

It is recognized, of course, that the implications of this technology are vast, and safeguards will be necessary to maintain the proper use of this templated voice technology. Indeed, this technology may require further use of authorization means to only allow authorized users to access and use the voice template technology and data. An additional necessity may be to have means for verifying that voices heard are either real or templated, in order to ensure against fraudulent or unauthorized use of such created voices. Legal mechanisms may need to be created to recognize this realm of technology, in addition to the licensing, contract, and other mechanisms already in existence in most countries.

In FIG. 1, connection means 41 represents pathways for energy or data flow which may be actual leads, light channels, or other electronic, biologic or other activatable paths among system components. In one embodiment power means 44 is shown within system 10, but may also be remote if desired.

In another embodiment of system 10, the algorithm, signal, code means or template which is created in whole or in part may be returned for storage or refinement within either storage means 22, template means 19, or other system component or architecture. This capability permits and facilitates improvement or adaptation of the specific voice template according to the instructions of the creator or another user. This could be accomplished, for example, if multiple data sets of the same person's voice could be inputted over time, or if different ages, development, or other changes to physiology or temperament of the originator of the voice occur. Indeed, it is possible to train the templated voice to recall the context of previous engagements and to include such knowledge in future operations. In these instances it may be useful to select a refinement mode to retrieve voice AA¹ template (AA¹ₜ) and refine the voice or template with a comparison and update using the analysis means 22 or input means 29. Yet another example includes location of a person with a voice BB that comprises one or more voice characteristics that are similar to voice AA which was the originator for voice template AA¹ₜ. In this case it may be useful to input the one or more similar characteristics from voice BB as either limited or general refinement inputs to voice AA¹ or voice template AA¹ₜ. It is then possible to also retain voice BB and create a voice BB¹ and voice template BB¹ₜ, either of which may be useful at a future date. Another example includes creation of a database of variously refined voices for a single originator of the voice, useful on demand or as appropriate by system or user, according to the situation that is presented. In yet another example, a service may be offered to voice match and provide suitable refinement tools, such as natural or artificially generated waveforms or other acoustic or signal elements, to refine voice templates according to the user's desires.

Prior to describing further embodiments of system 10 or related systems and methods, it is useful to examine possible applications of this technology. In general, there are applications so numerous as to be difficult to list them all. However, it is contemplated that any use of a voice-like noise, which is generated by data provided to and data resulting from a template or coding tool for creation of that voice-like noise, is captured within the scope of this invention, particularly when such coding tool is used with other noise or sound generating means, if needed, to re-create a voice sound that is virtually identical to the originator's actual voice. The use of the generated voice in completely new sentences, or other language structures, is also within the scope of this invention. The ability to provide machine, component, or computer readable code means as part of the signal forming or transmitting of the voice template process or product further facilitates use of this technology. Means to tie or activate use of this voice templating and voice generating technology to streaming or other forms of data allows for virtual dialog, which may be adaptive and intelligent, as well as merely informational or reactive, and with such dialog or conversations being with voices selected by the user. It is also recognized that the technology herein disclosed may be utilized with visual images as well as aural sounds.

Moreover, it is believed that a voice template as described herein may be created using data that does not include an actual enabling portion of an originator's voice, but that the enabling portion of the originator's voice may be used, possibly with other data, to validate the replication accuracy of the originator's voice. In this manner, it is possible to either use an enabling portion of a voice in either the templating of the voice or merely in the validation of the accuracy of an otherwise templated voice. A templated or replicated voice may be used to interact with or prompt users of computers or other machines and systems. The user may select such templated voice from either her own library of templated voices, another source of templated voices, or she may simply create a new voice. For example, templated voice AA¹ may be selected by the user for voicemail prompts or reading of texts, or other communication interface, whereas templated voice CC may be selected for use in relation to an interactive entertainment use. Troubleshooting or problems lurking in the user's machine, or alerting signals to a user of a device, may be identified or resolved by the user while working with templated voice DD. These are simply examples of how this technology will enable improved user interface and association by the user with functions, tasks, modes or other features by use of templated voice technology. Template selection and use, and generated voice creation and use may be accomplished either within the user's machine or device, partially within the user's machine or device, or external of the user's machine or device. There may be instances of only temporal use of one or more devices, such as in a hotel room, a visiting office, or other transient scenario or with a temporary device use, but which nevertheless provides the above features in the above-varied manner. For example, a traveler may wish to carry or access certain voices for accompaniment of the traveler on aircraft, or in hotel rooms. The invention may be useful in hospital or hospice rooms, or other locations. These uses are possible with one or more of the embodiments herein. Interestingly, this system may also be used by some individuals on their own voice and given as a legacy to others. Many other uses are within the scope of the teachings herein.

Other uses of the inventions disclosed herein include education, such as teaching children and others about historical events using a templated voice of choice. For example, if a parent desired her child to learn about race relations in the United States in the decade of the 1960s using one of the child's deceased grandparent's voices, then the templated voice of the selected grandparent (if available) would be designed, manufactured and designated for use. System 10 would access one or more databases to harvest information and knowledge about the designated topic and provide that information to one or more databases within system 10, such as situational database 33 for use as needed. The grandparents' templated voice EE¹ would be used, following access to the desired information, and the demand request would be met by the templated voice EE¹ commencing a discussion on the designated topic when desired. Such discussion can be saved for later use within system 10 or at a remote location as desired, or the discussion may be interactive between the “grandparent” i.e. the templated voice, and the child. This feature is possible by use of a voice recognition module to know in advance of the discussion the identity of the child's voice and to include adequate vocabulary and neural cognition of the various question combinations likely from the child. In addition, a bridge would be provided from the input and voice recognition module to the templated voice portion of the system, to enable responsiveness by the templated voice. Various speech recognition tools are conceivable for use in this manner, when so configured according to the novel uses described herein. Of course this configuration also requires means to rapidly search for the answer to the question and to formulate a response appropriate to the listening child. Clearly this example illustrates the extraordinary potential of this technology, particularly when combined with suitable data, system power, and system speed.

Alternatively, using the optional voice recognition module, it is possible to utilize only limited features to enable a listener of a templated voice to direct the generated voice to cease or continue, or to enable certain other features with certain commands. This would be a form of limited interactive mode appropriate for some but not all types of use. Even if the user chose not to use the optional features and instead merely arranged for a story or a discussion in the absent grandparents' voice, the effect and utility of this is enormous to this or other types of uses.

In the event the user wishes to only use a templated voice consistent with the education and life experiences of the originator of that voice, then such is possible through input of various filters or modifiers. For example, the templated voice may again be that of the grandparent selected above (templated voice EE¹), and the filter of DATA DATES is used with a selected date of “BEFORE DECEMBER 1963” for a discussion of race relations in the United States in the decade of the 1960s. The result would be a discussion that would not include any information that occurred after the designated date. In this example, the “grandparent” could not discuss the Voting Rights Act of 1965 or the urban riots of the late 1960s in that country. In similar fashion it is possible to adjust the numerous different aspects of the data or the templated voice itself, for example using the characteristics type of data shown in FIG. 4. It is recognized, however, that other adjustments are possible and contemplated within the scope of the inventions herein, and that the above examples are merely representative of the capabilities of the invented technology.

In another embodiment of the system and methods disclosed herein, a user may direct a templated voice of a loved one or someone else to read to the user. In this example it is possible for people of all ages to have books read to them in the voice of an absent or deceased family member or other person known to the user. When combined with a vast array of properly configured media and computer readable code means to implement the data links, this innovation alone will provide enormous benefit to users. This type of use has wide applications beyond the specific example just provided. Indeed, an even broader use of this technology in this manner is to have available a database of authorized and templated voices which may be accessible and useable by others for a fee or other form of compensation. When used for music, this technology has similar profound implications, particularly if one can access templated voices of past and present singers of renown- many of whose voices are still available for templating. Clearly, this technology enables a new industry of manufacturing, leasing, purchasing, or otherwise using voice templates and associated means, techniques and methods of conducting business therewith.

The invention may also have utility in medical treatments for certain minor or major psychological ailments, for which proper use of templated voice therapy may be quite palliative or even therapeutic. Yet another possible use of this technology is to create a newly designed voice for use, but one which has a basis or precursor in one or more templated voices from actual mammalian origin. Ownership and further use of the newly created voice may be controllable under various means or legal enforcement, such as licensing or royalties and the like. Of course, such voices may be retained as private possessions for limited use by the creator as well. One can imagine the nature of such libraries which may be created. Such voices will represent the creative aspirations of the creator, but each voice will actually have a component or strain of actual mammalian voice as a basis through use of the templating tool or code, similar to a strand of tissue DNA but applicable to a specific voice. This type of combination presents powerful new communication capabilities and relationships based on voice and other sounds created by mammals.

Systems according to the invention may be handheld or of other size. Systems may be embedded in other systems or may be stand alone in operation. The systems and methods herein may have part or all of the elements in a distributed, network or other remote system of relationship. Systems and methods herein may utilize downloadable or remotely accessible data, and may be used for control of various other systems or methods or processes. Embodiments of the invention include exposed interface routines for requesting and implementing the methods and operations disclosed herein but which may be carried out in whole or in part by other operating or application systems. The templating process and the use of templated voices may be accomplished and used by either mammals or artificial machines or processes. For example, a bot or other intelligent aide may create or use one or more templated voices of this type. Such an aide may also be utilized to search for voices automatically according to certain general or limited criteria, and may then generate templated voices in voice factories, either virtual or physical. In this manner, large databases of templated voices may be efficiently created. In this or similar systemic use, it may be desirable to create and apply data or other types of tagging and identification technology to one or more portions of the actual voice utilized to create a templated voice.

The following are examples of applications using the technology disclosed herein. These are not meant to be limiting, but rather are provided as representative possible uses in addition to those enabled and otherwise suggested elsewhere in this disclosure.

### EXAMPLE I

A templating process using elements of the embodiments herein yields a voice coding signal, comprising the logic structure of characteristics of a specific voice essential for accurately replicating the sound of that voice.

### EXAMPLE 2

A personal computer prompter and updater, status reporter, or mate using one or more selected voices using the technology herein.

### EXAMPLE 3

A home energy monitor, reporter, or mate, using one or more selected voices using the technology herein.

### EXAMPLE 4

A hotel room assistant, or automobile assistant to prompt the user according to desired prompting, such as for example a wake-up call in a hotel in the voice selected by the user. In similar manner, an operator of a vehicle might receive information in the voice or voices selected by the user.

### EXAMPLE 5

Using one or more selected voices using the technology herein in a personal digital assistant, a handheld personal computing device, or other electronic device or component at any time for voice capture, mate, alerter, etc.

### EXAMPLE 6

Creating or managing one or more selected voices or voice templates in computer/electronic chip logic, instructions, or code means for implementing the business and technology methods and manufactures disclosed herein.

### EXAMPLE 7

Using the voice template technology in combination with other visual media, such as with a photograph, digital video or a holographic image.

### EXAMPLE 8

Using the technology disclosed herein with a flash-memory based profile card for plug-in with any device that can record, play, or reconstitute a voice.

### EXAMPLE 9

Using the technology disclosed herein with a personal device that scans and updates downloadable information for a user as desired in voice or voices of one's choosing. For example, this may be useful for organizing actions capable of being done by a bot, such as an info-bot for background searching and interface while the user is not available and then reporting status to the user in one or more designated voices using the technology herein.

### EXAMPLE 10

Using the technology disclosed herein in combination with one or more components of a vehicle or other transportation system.

### EXAMPLE 11

Using the technology disclosed herein with one or more components of an airplane for an in-flight companion.

### EXAMPLE 12

Using the technology disclosed herein as a safety reminder when used with one or more components of gear or equipment in the workplace, such as a personal computer posture monitor, electrical equipment, dangerous equipment, etc.

### EXAMPLE 13

Using the technology disclosed herein as an add-on to other voice activated systems, such as dictation devices, as prompts, companions, or text readers.

### EXAMPLE 14

Using the technology disclosed herein use as social mediation or control mechanisms, such as a tool against road rage or other forms of anger and frustration, activatable by driver or automatically, or by other means.

### EXAMPLE 15

Using the technology disclosed herein as a teaching tool in home, school or the workplace.

### EXAMPLE 16

Using the technology disclosed herein for inspirational readings.

### EXAMPLE 17

Using the technology disclosed herein as a tool to act as a family history machine.

### EXAMPLE 18

Using the technology disclosed herein as a MusicMatch™ brand of voice sourcing and matching technology for singers with best or desired voice.

### EXAMPLE 19

Using the technology disclosed herein use as a VoiceSelect™ brand of movie or video match technology to utilize preferred voices for templating of entertainment script already used by the original performer or subsequently created for voice template technology combination uses.

### EXAMPLE 20

Using the technology disclosed herein use as an “alter ego” device such as a handheld unit which engages on “SelectVoice™” brand or “VoiceX™” brand mode(s) of operation and has a database of images of those who match the voice as well as anonymous models which can be selected, similar to that referred to in Example 7.

### EXAMPLE 21

Using the technology disclosed herein to create a profile of a profiled or templated voice.

### EXAMPLE 22

Using the technology disclosed herein use as a bedtime reader or a night mate in a dwelling for monitoring and interactive security.

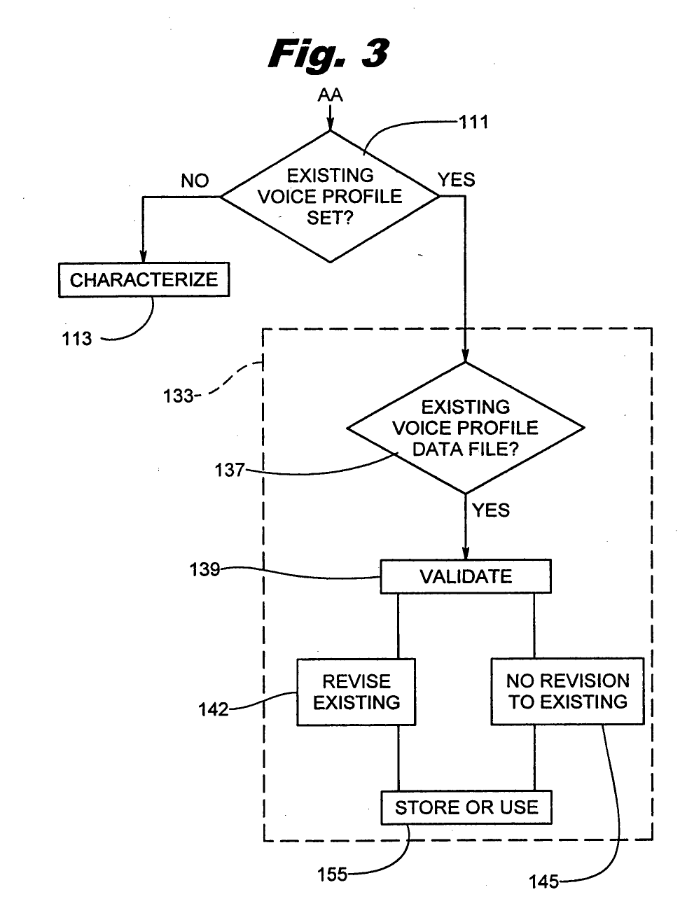

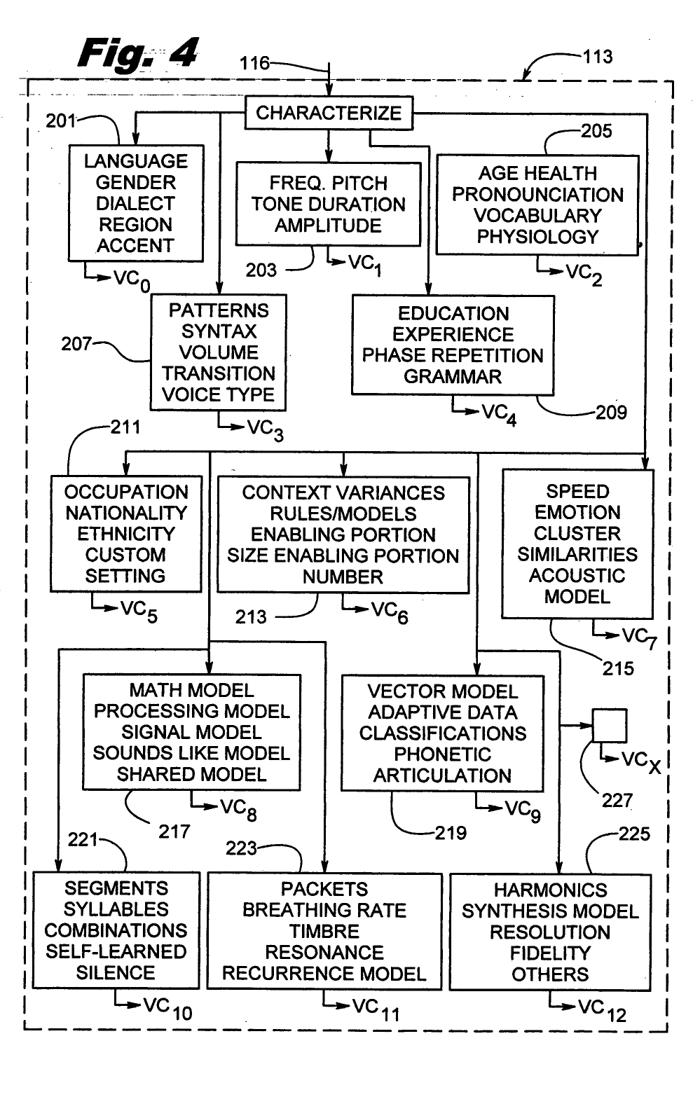

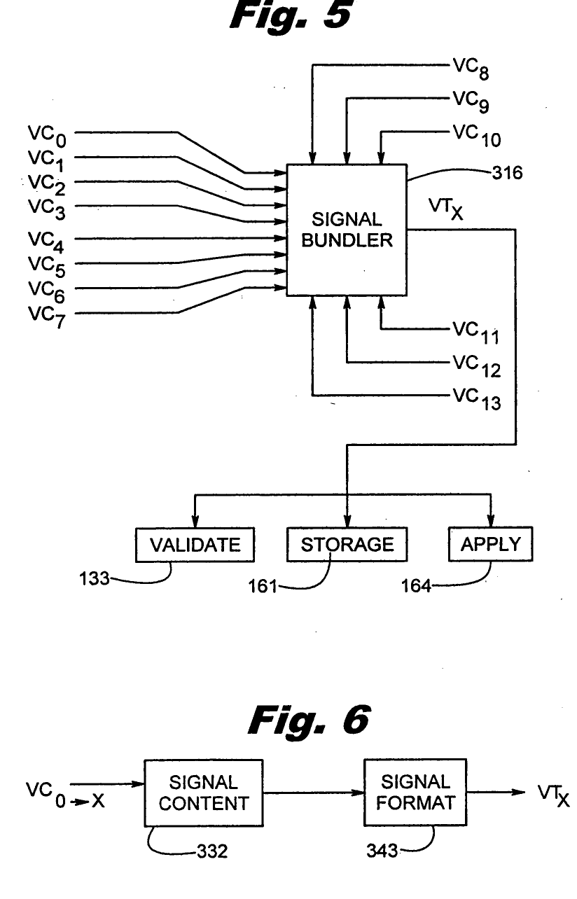

FIG. 2 is a flow diagram of one embodiment of a voice capture subsystem which may comprise computer readable code means or method for accomplishing the capture, analysis and use of a voice AA designated for templating. FIG. 3 is one embodiment of a voice analysis subsystem which may comprise logic or method means for efficiently determining voice data characterization routing. In these embodiments, voice AA is captured in acquisition module or step 103 and then routed by logic steps and data conductive pathways, such as pathway 106, through the templating process. Capture may be accomplished by either digital or analog methods and components. The signal which then represents captured voice AA is routed through analysis means 111 or method to determine whether an existing voice profile or template matches voice AA. This may be accomplished, for example, by comparing one or a plurality of characteristics (such as those shown in voice characterization subsystem 113 of FIG. 4) as determined by either acquisition module 103 or analysis means 111, and then comparing those one or more characteristics with known voice profiles or templates available for access, such as at analysis step 111. Representative feedback and initial analysis loop 114 facilitates these steps, as does pathway 116. Such comparison may include querying of a voice profile database or other storage medium, either locally or remotely. The analysis step at analysis module 111 and voice characterization subsystem 113 may be repeated according to algorithmic, statistical or other techniques to affirm whether the voice being analyzed does or does not relate or match an existing voice profile or data file. FIG. 4 provides further detail of voice characterization subsystem 113.

Referring again to FIG. 2, if the signal corresponding to voice AA does not have a match or is not identified with an existing voice profile set then the signal is routed to the voice characterization subsystem for comprehensive characterization. However, if an existing voice profile data file matches the profile signal of voice AA, then creation of a template may not be required at module/step 127. In that situation, the signal might be analyzed and/or characterized for possible generation of a revised profile or template- which itself may then be stored or applied. This situation might occur, for example, when additional characterization data is available (such as size of enabling portion, existence or lack of stress, or other factors) which had not been previously available. Accordingly, a specific voice data file might comprise a plurality of templates. This is a validation process, having logic steps and system components shown generally at validation subsystem 133 in FIGS. 2 and 3. It is emphasized that, as to relational location to subsystems and components, these Figures are generally schematic. Also, as shown in FIG. 3, after determination that a voice profile data file exists (step 137), then the validation logic at step 139 will, optionally, occur. If a revision of an existing template is merited, then it is generated at step 142. Alternatively, logic step 145 notes that no revision to an existing template is to be made. Following either steps 143 or 145, then the new, revised, or previous voice profile or template is stored or used at step 155.

The template creation module/step 127 of FIG. 2 comprises utilizing the voice characterization subsystem to create a unique identifier, preferably a digital identifier, for that specific voice being templated or profiled. This data is similar, in the abstract, to genetic codes, gene sequence codes, or bar codes, and like identifiers of singularly unique objects, entities or phenomena. Accordingly, applicants refer to this voice profile or template as “Voice Template Technology™” as well as “Voice DNA™ or VDNA™” and “Voice Sequence Codes™ or Voice Sequence Coding™”. The terms “Profile, Profiles or Profiling” and derivative terms may be substituted in the above trademark or other reference terms for this new technology. Following completion of template creation, the voice template may be stored (shown at storage module or step 161 or applied in use at module or step 164).

FIG. 4 is a schematic representation of a voice characterization subsystem. This disclosure comprises at least one embodiment of characterization data and means for determining and characterizing salient data to define a voice using voice templating or profiling, as disclosed herein. As shown, various types of data is available for comparison in formulating the characterization data. This characterization data will then be used to create the voice template or profile according to coding criteria. Although the data in FIG. 4 appears to be arranged in discreet modules, an open comparator process may be preferred in which any data may be accessed for comparison in any of various sequences or weighted priorities. Regardless, as shown in this figure, data may comprise the categories of language, gender, dialect, region, or accent (shown as “Voice Characteristics” output signal VC₀ at module or step 201); frequency, pitch, tone, duration, or amplitude (shown as output signal VC₁ at module or step 203); age, health, pronunciation, vocabulary, or physiology—either genetic or otherwise (shown as output signal VC₂ at module or step 205); patterns, syntax, volume, transition, or voice type (shown as output signal VC₃ at module or step 207); education, experience, phase, repetition, or grammar (shown as output signal VC₄ at module or step 209); occupation, nationality, ethnicity, custom or setting (shown as output signal VC₅ at module or step 211); context, variances, rules/models, enabling portion type, size or number (shown as output signal VC₆ at module or step 213); speed, emotion, cluster, similarities, or acoustic model (shown as output signal VC₇ at module or step 215); math model, processing model, signal model, sounds-like model, or shared model (shown as output signal VC₈ at module or step 217); vector model, adaptive data, classifications, phonetic, or articulation (shown as output signal VC₉ at module or step 219); segments, syllables, combinations, self-learned, or silence (shown as output signal VC₁₀ at module or step 221); packets, breathing rate, timbre, resonance, or recurrence model (shown as VC₁₁ at module or step 223); harmonics, synthesis models, resolution, fidelity, or other characteristics (shown as output signal VC₁₂ at module or step 225); or various other techniques for uniquely identifying a portion (whether fractional or in its entirety) of a voice. For example, this may further include a digital or analog voice signature, modulation, synthesizer input data, or other data formed or useful for this purpose, all of which is shown as output signal VCₓ at module or step 227.

It is recognized that one or more data types from any one or more modules or steps may provide value to a voice template. Also, for purposes of this invention, VCₓ encompasses any known categorization technique at the time of interpretation, regardless of mention herein, provided it is useful in then defining a unique voice profile or template for a specific voice—and is used according to the novel teachings disclosed herein. Again, it is recognized that data combined in voice characteristic files and output signals VC₀, VC₁, VC₂, VC₃, VC₄, VC₅, VC₆, VC₇, VC₈, VC₉, VC₁₀, VC₁₁, VC₁₂, and VCₓ may be prioritized and combined in various ways in order to accurately and efficiently analyze and characterize a voice, with VCₓ representing still further techniques incorporated herein by reference.

FIGS. 5 and 6 illustrate an exemplary signal bundler suitable for receiving the various voice characteristic data, such as digital or coded data representative of the information deemed relevant and formative of the voice being templated. The signal bundler 316 then combines the output of signal content module or step 332 and values/scoring from one or more signals VC₀-Vₓ and formats the signal or code at module or step 343 as appropriate for proper transfer and use by various potential user interfaces, devices or transmission means to create an output voice template, code, or signal VTₓ. It is recognized that various methods are possible to create a unique identifier to delineate the various voice characteristics—and that such various possibilities are enabled herein in view of the broader context and scope of this invention—to a certain degree independent of some component methodology.

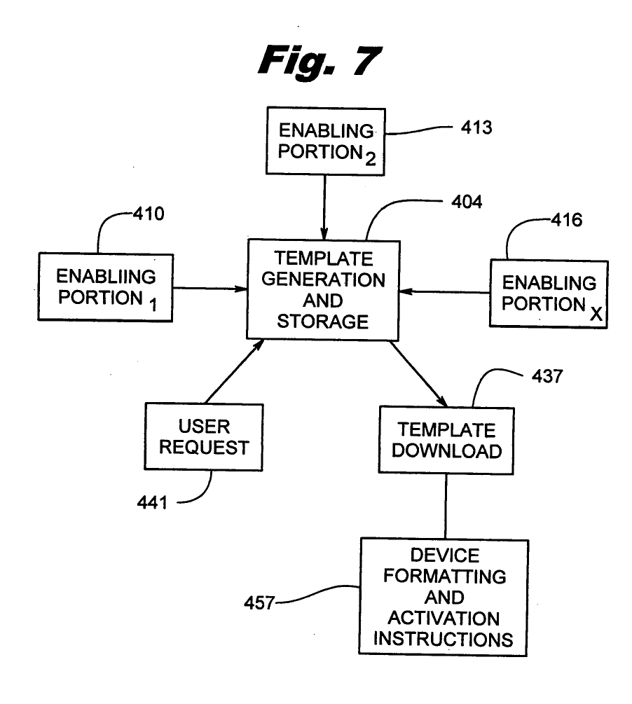

FIG. 7 is a representative organization and method of an electronic query and transfer between a voice template generation or storage facility 404 and a remote user. In this representation, enabling portions may be sent to a remote voice template generation or storage facility 404 by any number of various users 410, 413, 416. The facility 404 then generates or retrieves a voice template data file and creates or retrieves a voice template signal. The template signal is then transmitted or downloaded to the user or its designee, shown at step 437. At the time of download, or later, following a user request 441, the template signal is formatted for appropriate use by a destination device, including activation instructions and protocols, shown at step/module 457.

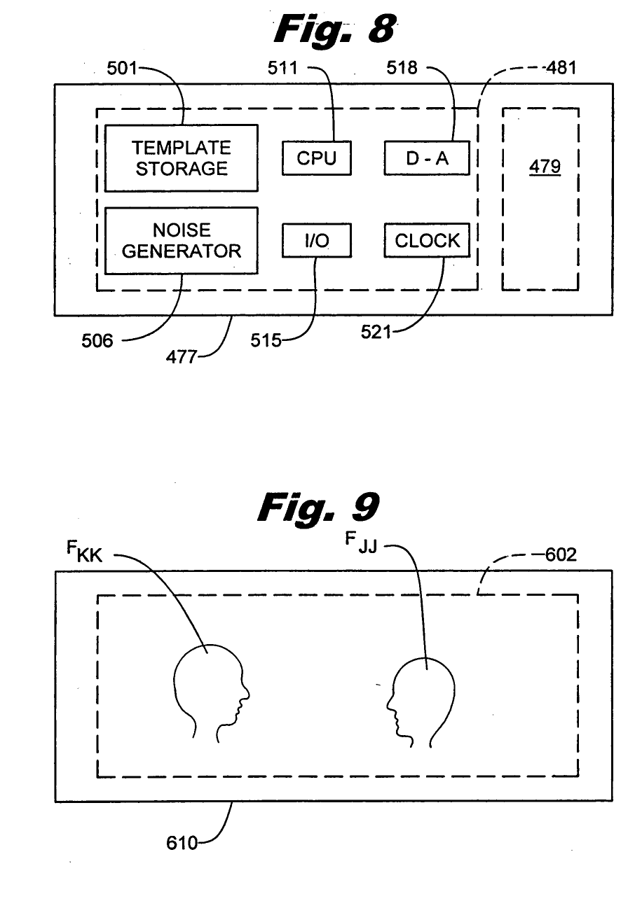

FIG. 8 is a schematic representation of a mobile medium, such as a card, disk, or chip on which are essential components, depending on the user mode and need, for utilizing voice template technology. For example, using FIGS. 7 and 8, a hotel door card 477 may be provided at check-in to a hotel by a traveler. However, in addition to the normal onsite security code programming and circuitry 479 applied to the card, additional features incorporating aspects of this invention may be made available. A schematic representation of optional features within such a card include means 481 for receiving and using a voice template for a voice or voices selected by the traveler for various purposes during the traveler's stay at the hotel. As shown, such features may include a template receiving and storage element 501, a noise generator or generator circuitry 506, a central processing unit 511, input/output circuitry 515, digital to analog/analog to digital elements 518, and clock means 521. Again, various other elements may be utilized, such as voice compression or expansion means—such as those known in the cellular phone industry, or other components to enable the card to function as desired. The user may then enjoy dialog or interface with inanimate devices within the hotel in the voice(s) selected by the traveler. Indeed, a traveler profile may even retain such voice preference information, as appropriate, and certain added billings or benefits may accrue through use of this invention. It is recognized that the invention may be employed in a wide variety of applications and articles, and the example of FIGS. 8 and 9 should not be considered limiting.

FIG. 9 is a depiction of a photograph 602 which is configured for interactive use of voice template technology with voice JJ attributable to figure F_{JJ} and voice KK attributable to figure F_{KK}. Means are combined with the frame 610 or other structure, whether computer readable code means or simple three dimensional material, for interfacing the subjects or objects of the photo (or other media) with the, appropriate voice templates to recreate a dialogue that either likely occurred or could have occurred, as desired by the user.

It is recognized that various means and methods exist to capture, analyze, and synthesize real and artificial voice components. For example, the following United States patents, and their cited or listed references, illustrate a few of the means for capturing, synthesizing, translating, recognizing, characterizing or otherwise analyzing voices, and are incorporated herein in their entirety by reference for such teachings: U.S. Pat. Nos. 4,493,050; 4,710,959; 5,930,755; 5,307,444; 5,890,117; 5,030,101; 4,257,304; 5,794,193; 5,774,837; 5,634,085; 5,704,007; 5,280,527; 5,465,290; 5,428,707; 5,231,670; 4,914,703; 4,803,729; 5,850,627; 5,765,132; 5,715,367; 4,829,578; 4,903,305; 4,805,218; 5,915,236; 5,920,836; 5,909,666; 5,920,837; 4,907,279; 5,859,913; 5,978,765; 5,475,796; 5,483,579; 4,122,742; 5,278,943; 4,833,718; 4,757,737; 4,754,485; 4,975,957; 4,912,768; 4,907,279; 4,888,806; 4,682,292; 4,415,767; 4,181,821; 3,982,070; and 4,884,972. None of these references illustrates the inventive contributions claimed or elsewhere disclosed herein. Rather, the above patents illustrate tools that may be useful rather than necessary in practicing one or more embodiments of this invention. Thus, it is recognized that various systems, products, means, methods, processes, data formats, data related storage and transfer media, data contents and other aspects are contemplated within this invention to achieve the novel and nonobvious innovations, advantages, products and applications of the technology disclosed herein. Therefore the above disclosures shall be considered exemplary rather than limiting, where appropriate, so that the claims are afforded the breadth of scope to which this pioneering technology should be entitled without limitation by the pace of development and availability of implementing technologies.

1. A system for capturing an enabling portion of a specific voice sufficient for using that portion as a template in further use of the voice, comprising:
a. means for capturing an enabling portion of a voice in a form useful for analysis as to voice characteristics;
b. analysis means for receiving and analyzing the captured voice and for characterizing elements of the captured voice as characterization data;
c. storage means for receiving characterization data from the analysis means for a specific voice; and
d. retrieval means for retrieving the analysis and characterization data for further use.

2. The system of claim 1 in which the means for capturing the voice comprises digital recording means.

3. The system of claim 1 in which the means for capturing the voice comprises a flash memory card.

4. The system of claim 1 in which the means for capturing the voice comprises analog recording means.

5. The system of claim 1 in which the means for capturing the voice comprises input means for receiving a live voice and for transmitting that live voice to the analysis means.

6. The system of claim 1 in which the analysis means comprises digital data storage means.

7. The system of claim 1 in which the analysis means comprises means for identifying specific patterns, syntax, frequency, pitch and tones of speech in the captured voice data.

8. The system of claim 1 in which the analysis means comprises means for identifying specific vocabulary, pronunciation, or accent unique to the captured voice.

9. The system of claim 1 in which the analysis means comprises means for identifying specific features unique to the captured voice deriving principally from specific anatomic structures of the originator of the voice.

10. The system of claim 1 in which the analysis means comprises means for determining the vocabulary of the originator of the captured voice.

11. The system of claim 10 in which the analysis means comprises means for setting the vocabulary as characterization data for use in forming a future templated voice.

12. The system of claim 1 in which the analysis means comprises digital processing apparatus for digitally processing input data in the form of a voice or digital representation of a recorded voice.

13. The system of claim 1 in which the analysis means comprises second input means for receiving additional data regarding the physiology of the voice originator.

14. The system of claim 13 in which the analysis means second input means comprises digital signal processor means suitable for selectively receiving audio or other data comprising visualization information on the morphology of the voice originator.

15. The system of claim 1 in which the analysis means comprises comparison means for comparing an input voice data set with stored data comprising age data, language data, educational data, gender data, occupation data, accent data, nationality data, ethnic data, voice type data, custom data and setting data.

16. The system of claim 1 in which the analysis means comprises third input means for receiving data regarding the voice originator comprising age data, educational data, gender data, occupation data, accent data, nationality data, ethnic data, voice type data, custom data, language data and setting data.

17. A method of creating a voice-like noise which is identical in sound to an actual specific human's voice, comprising the steps of:
a. capturing an enabling portion of a specific human's voice for storage and use:
b. storing the enabling portion of the specific human's voice;
c. analyzing the enabling portion to identify essential components or characteristics of the captured voice; and
d. utilizing the identified essential components or characteristics to create a new voice which, when assigned data from one or more database means and when heard, sounds identical in all respects to the voice of the specific human's voice to a listener having normal aural discretion abilities.

18. The method of claim 17 in which the analyzing step comprises the steps of identifying the components in the captured enabling portion of the specific human's voice relating to at least one of the components including frequency, tone, pitch, volume, accent, gender, harmonic structure, acoustic power, phonetic or timing accent, power and periodicity.

19. The method of claim 18 in which the step of capturing an enabling portion of a specific human's voice for storage and use includes capturing either larynx generated noise or turbulence generated noise of the specific human's voice.

20. A method of accurately replicating a human voice comprising the steps of:
a. identifying a minimum size data set comprising a combination of words, sounds or phrases which must be emitted by the originator of a voice to be replicated;
b. capturing the emission of the combination of words, sounds or phrases by the originator of the voice to be replicated in a medium;
c. analyzing the captured emission to identify voice characteristics of the originator of the voice sufficient to allow artificial generation of the voice, using the identified characteristics, so that the artificially generated voice is substantially identical in all respects to a listener having normal aural discretion abilities when the listener hears the generated voice utilizing some language components not contained in the captured emission of the originator's actual voice.

21. An article of manufacture comprising:
a. a computer usable medium having computer readable program code means embodied therein for causing replication of a human voice, the computer readable program code means in said article of manufacture comprising:
b. computer readable program code means for causing a computer to effect an analysis of a captured enabling portion of an originator's voice to identify voice characteristics data sufficient to allow artificial generation of the voice; and
c. computer readable program code means for causing use of the identified voice characteristics data to artificially generate a voice, so that the artificially generated voice is substantially identical in sound and usage to a listener when the listener hears the generated voice utilizing some language components not contained in the captured emission of the originator's actual voice.

22. The article of manufacture of claim 21 further comprising computer readable program code means for storing the generated voice for later use.

23. The article of manufacture of claim 21 further comprising computer readable program code means for using the voice characteristics data to create a voice profile of the originator of the voice.

24. The article of manufacture of claim 21 further comprising computer readable program code means for accessing data base means for storing data comprising age data, educational data, gender data, occupation data, accent data, language, nationality data, ethnic data, voice type data, custom data, general data and setting data.

25. A computer program product for use with an aural output device, said computer program product comprising:
a. a computer usable medium having computer readable program code means embodied therein for causing replication of a human voice via an output aural device, the computer program product comprising:
b. computer readable program code means for causing a computer to effect an analysis of a captured enabling portion of an originator's voice to identify voice characteristics data sufficient to allow artificial generation of the voice; and
c. computer readable program code means for causing use of the identified voice characteristics data to artificially generate and output a voice via an aural output device, so that the artificially generated voice is substantially identical in sound and usage to a listener when the listener hears the generated voice utilizing some language components not contained in the captured emission of the originator's actual voice.

26. A computer program product for use with a display device, said computer program product comprising:
a. a computer usable medium having computer readable program code means embodied therein for causing replication of a human voice and verification of the accuracy of the replicated voice displayed on the display device, the computer program product comprising:
d. computer readable program code means for causing a computer to effect an analysis of a captured enabling portion of an originator's voice to identify voice characteristics data sufficient to allow artificial generation of the voice; and
e. computer readable program code means for causing use of the identified voice characteristics data to artificially generate a voice and to compare the characteristics of the generated voice to the originator's voice on a display device, so that the artificially generated voice is substantially identical in sound to a listener when the display device so indicates and when a listener actually hears the generated voice utilizing some language components not contained in the captured emission of the originator's actual voice.

27. A computer program product for use with an aural output device, said computer program product comprising:
a. a computer usable medium having computer readable program code means embodied therein for initiating replication of a human voice via an output aural device, the computer program product comprising:
b. computer readable program code means for causing a computer to receive and activate a voice characteristics data file unique to a specific voice sufficient to allow artificial generation of the voice; and
c. computer readable program code means for causing use of the identified voice characteristics data to artificially generate and output a voice via an aural output device, so that the artificially generated voice is substantially identical in sound to a listener when the listener hears the generated voice and a captured emission of the originator's actual voice.

28. A computer program product for use with an electronic device, said computer program product comprising:
a. a computer usable medium having computer readable program code means embodied therein for initiating replication of a human voice, the computer program product comprising:
b. computer readable program code means for causing receipt and activation of a voice characteristics data file unique to a specific voice sufficient to allow artificial generation of the voice; and
c. computer readable program code means for causing use of the identified voice characteristics data file and a noise generation means sound output to artificially generate a voice, so that the artificially generated voice is substantially identical in sound to the originator's actual voice.

29. A memory for storing data for access by an application program being executed on a data processing sub-system, comprising:
a. a data structure stored in said memory, said data structure including information resident in a database used by said application program and including:
b. at least one voice enabling portion data file stored in said memory, each of said voice enabling portion data file set containing information substantially different from any other voice enabling portion data file set;
c. a plurality of voice characteristics data files containing different reference information for a plurality of voice characteristics; and
d. a plurality of voice profile sets each having at least one voice profile data file having data unique to that data file only; wherein the data structure allows access to the voice characteristics data files and the voice profile data files to conduct comparison operations with at least one voice enabling portion data file.

30. A data processing system executing an application program and containing a database used by said application program, said data processing system comprising:
a. CPU means for processing said application program; and
b. memory means for holding a data structure for access by said application program, said data structure being composed of information resident in a database used by said application program and including:
at least one voice enabling portion data file stored in said memory, each of said voice enabling portion data file set containing information substantially different from any other voice enabling portion data file set;
a plurality of voice characteristics data files containing different reference information for a plurality of voice characteristics;
a plurality of voice profile sets each having at least one voice profile data file having data unique to that data file only; and
c. wherein the data processing system allows access to the voice characteristics data files and the voice profile data files to conduct comparison operations with at least one voice enabling portion data file.

31. A computer data signal embodied in a transmission medium comprising:
a. an encryption source code for a unique voice profile template useful for keying additional electronic noise to create a specific generated voice; and
b. a carrier medium suitable for carrying the encryption source code to a location and configured so that the encryption source code is removable from the carrier medium to be applied as a key to create a generated voice.

32. A method for using a selected voice as a personal voice assistant with an electronic device, comprising the steps of:
a. activating electronic means for accessing a remote database;
b. transmitting a signal portion to a remote database having a voice database containing a plurality of voice profile sets each having at least one voice profile data file having data unique to that data file only and identifiable by a unique identifier;
c. transmitting a signal portion to the remote database to uniquely identify a desired data file and then to effect transfer of the data file content to the user's designated electronic device location; and
d. implementing use of the selected and transferred data file as a voice template, in combination with appropriate noise generated either by the electronic device or other means for generating such noise, so that as desired the user may receive noise from the electronic device in the sound of the selected voice as determined by the identified voice.

33. The method of claim 32 in which the data file includes data characteristics of the selected voice arranged as computer readable program code means for causing use of the identified voice characteristics data to artificially generate a voice template.

34. The method of claim 32 in which the implementing step comprises application of authorization means to only allow authorized users to access and use the voice template technology and data.

35. The method of claim 32 in which the implementing step comprises application of selectively accessible verification means for verifying that voices heard are either real or template generated.

36. A method of doing business in which a system is used for capturing an enabling portion of a specific voice sufficient for using that portion as a template in further use of the voice, comprising the steps of:
a. capturing an enabling portion of a voice in a form useful for analysis as to voice characteristics;
b. inputting the enabling portion into an analysis module for characterizing elements of the captured voice as characterization data;
c. receiving the characterization data from the analysis module for a specific voice; and
d. storing the characterization data for further use.

37. The method of claim 36 in which the means for capturing the voice comprises digital input means.

38. The method of claim 36 in which the enabling portion of the voice is received electronically.

39. The method of claim 36 in which the characterization data is bundled to form a voice template signal useful for combining with generated noise to create a templated voice which sounds like the original specific voice.

40. The method of claim 36 in which the templated voice is controlled so that the templated voice may receive speech input commands to elicit new words in the templated voice but which were not inputted by the specific voice.

41. An automated machine for capturing an enabling portion of a specific voice and for using that portion as a template useful for further use of the templated voice, comprising:
a. an acquisition module for acquiring an enabling portion of a voice in a form useful for analysis as to voice characteristics;
b. an analysis module for receiving and analyzing the captured voice and for characterizing elements of the captured voice as characterization data; and
c. a template generator module for automatically generating a voice template signal as a unique identifier of the acquired specific voice.

42. The machine of claim 41 further comprising communication means for communicating with storage means for receiving characterization data from a database.

43. The machine of claim 41 further comprising communication means for communicating with storage means for storing the generated template until requested.

44. An online method for creating voice templates and generating revenue for such generation, comprising:
a. capturing an enabling portion of a specific voice;
b. analyzing the enabling portion of the specific voice to generate a data profile which defines the characteristics of the captured voice in a way that can be reconstituted for later use;
c. generating a voice template signal as a unique identifier of the acquired specific voice; and
d. providing at least one generated data profile for commercial use by another.

45. A machine operated method for creating a voice template and generating revenue for such generation, comprising:
a. capturing an enabling portion of a specific voice;
b. analyzing the enabling portion of the specific voice to generate a data profile which defines the characteristics of the captured voice in a way that can be reconstituted for later use;
c. using the data profile, generating a voice template signal as a unique identifier of the captured specific voice; and
d. providing at least one voice template signal for commercial use.

46. A business method for creating a voice template, comprising:
a. capturing an enabling portion of a specific voice or templated voice;
b. using computer means, analyzing the enabling portion of the voice to generate a data profile which defines the characteristics of the captured voice in a way that can be reconstituted for later use;
c. electronically generating or retrieving a voice template signal as a unique identifier of the captured voice; and
d. providing at least one voice template signal for commercial use.

47. The method of doing business of claim 46 in which the step of providing is accomplished on an electronic data exchange.

48. A method for creating a voice template from a plurality of voices, comprising:
a. capturing an enabling portion of a plurality of voices or templated voices;
b. using computer means, analyzing the enabling portions of the voices to generate a data profile which defines the characteristics of the captured voices in a way that can be bundled as a single voice signal suitable for reconstitution for later use; and
c. electronically generating a voice template signal as a unique identifier of the newly generated voice.

49. A method of accurately replicating a human voice of someone who lost the ability to speak in the desired normal voice, comprising the steps of:
a. identifying a minimum size data set comprising a combination of words, sounds or phrases which must be emitted by the originator of a voice to be replicated;
b. capturing the emission of the combination of words, sounds or phrases by the originator of the voice to be replicated in a medium;
c. analyzing the captured emission to identify voice characteristics of the originator of the voice sufficient to allow artificial generation of the voice, using the identified characteristics, so that the artificially generated voice is substantially identical in all respects to a listener having normal aural discretion abilities when the listener hears the generated voice utilizing some language components not contained in the captured emission of the originator's actual voice.

50. The method of claim 49 further comprising identifying the voice to be replicated by genetic code.

51. The method of claim 49 further comprising a step of validating or adjusting the artificially generated voice by use of genetic code analysis of the originator of the voice being replicated.

52. A method of accurately replicating an actual human voice, comprising the steps of:
a. identifying a minimum size data set comprising a combination of fractions or segments of actual words, sounds or phrases which were emitted by the originator of the voice to be replicated;
b. capturing the emission of the combination of words, sounds or phrases by the originator of the voice to be replicated in a medium;
c. analyzing the captured emission to identify voice characteristics of the originator of the voice by analysis of fractions or segments of the words, sounds or phrases sufficient to allow artificial generation of the voice, using the identified characteristics, so that the artificially generated voice is substantially identical in all respects to a listener having normal aural discretion abilities when the listener hears the generated voice utilizing some language components not contained in the captured emission of the originator's actual voice.

53. A method for creating a voice template from a plurality of voice fragments, comprising:
a. capturing an enabling portion of a plurality of voice fragments;
b. using computer means, analyzing the enabling portions of the voice fragments to generate a voice fragment data code which defines the characteristics of the captured voice fragments in a way that can be bundled as a single voice signal suitable for reconstitution for later use; and
c. electronically generating a voice template signal as a unique identifier of the newly generated voice.
